(19) United States
(12) Patent Application Publication
(10) Pub. No.: US 2003/0126433 A1
(43) Pub. Date: Jul. 3, 2003

(54) Method and system for performing on-line status checking of digital certificates

(76) Inventor: Waikwan Hui, Fremont, CA (US)

Correspondence Address: WAGNER, MURABITO & HAO LLP, Two North Market Street, Third Floor, San Jose, CA, 95113, US

(21) Appl. No.: 10/033,461

(22) Filed: Dec. 27, 2001

(51) Int. Cl. H04L 9/00

(52) U.S. Cl. 713/158

(57) ABSTRACT

A method and system for performing on-line status checking of digital certificates. Specifically, the present invention describes a communication system having a client and a server coupled together. The client requests information from the server. A secure communication session is established between the client and the server for checking the revocation status of a digital certificate associated with the information. As such, further authentication of communication about the certificate status between the client and the server is unnecessary. A status request pertaining to the digital certificate is sent by the client to the server. The server checks the revocation status of the digital certificate against a current digitally signed certificate revocation list. The server notifies the client as to the revocation status of the digital certificate prior to any transmission of information.

### BACKGROUND OF THE INVENTION

1. Field of the Invention

Embodiments of the present invention relate to the field of digital certificates. More particularly, embodiments of the present invention relate to the performance of on-line status checking of digital certificates.

2. Related Art

Digital certificates are widely used over communication networks and in the field of electronic commerce for document and identity authentication purposes. In general, such digital certificates are used to certify the identity of an entity in the digital world, particularly as defined by the public key infrastructure (PKI). In any PKI, a certificate authority (CA) is a trusted entity that issues, renews, and revokes certificates. An end entity (EE) is a person, router, server, or other entity that uses a certificate to identify itself.

To participate in a PKI, an end entity enrolls, or registers, into the PKI system. The end entity typically initiates enrollment by giving the CA some form of identification and a newly generated public key in the form of a “certificate request.” The CA uses the information provided to authenticate, or confirm the identity. In addition to authenticating the end entity, the CA uses the public key to ensure “proof of possession,” that is, as cryptographic evidence that the certificate request was signed by the holder of the corresponding private key. Finally, the CA issues a “certificate” that is associated with the end entity's identity and its associated public key. As such, the certificate has a one-to-one correspondence with the end entity's private and public key.

As digital certificates are issued and used, they often are revoked for various reasons. Revocation can be defined as the removal of a certificate's validity prior to its certificate expiration date. A typical example would be when a private key is stolen, illegally duplicated, or otherwise compromised. In that case, it would be necessary for certificates associated with that private key to be revoked. Otherwise, any person holding the private key, with the proper access knowledge, could generate information, software, and the like, and claim that they originate from the original owner of the private key.

Many other situations may require the revocation of a certificate. For example, each of the following cases illustrate situations involving revoked certificates: when the relationship between an issuing party and an organization is severed or suspended; an issuing authority ceases to operate; there is suspected private key compromise; a certificate is no longer required by the client; an employee holding a private key on the part of a corporation leaves that corporation; etc.

A requirement of PKI is to maintain a path or chain of trust. It is therefore good to have a mechanism by which digital certificates can be verified as to its validity. One solution among many standards in use today is the Certificate Revocation List (CRL). The CRL is a published data structure that is periodically updated. The CRL contains a list of revoked certificate serial numbers. The CRL is time-stamped and digitally signed by the CA who issues the certificates, or other third party entities, such as a revocation service. CRLs are currently defined in the X.509 standard and its various versions.

One specific problem is that a user may not necessarily update the information contained within a CRL that is loaded on that user's system. As such, that user would compare a certificate against an out-of-date CRL and assume the certificate is valid when the certificate may in fact be revoked. Thus, the user would be unaware that any information authenticated with the now revoked digital certificate could be compromised, and could possibly jeopardize the integrity of the user's system should the user download injurious information.

Another problem is that the CRL that is maintained by a certificate authority or any other CRL service has a lag time between receiving a report that a certificate has been revoked and posting the certificate on the CRL. In addition, a further period of time may elapse before any user will actively seek out the CA or CRL service for the most current CRL. As such, even though a user may have the most up-to-date CRL, the user may still receive information that has been authenticated with a certificate that has been revoked.

### SUMMARY OF THE INVENTION

Embodiments of the present invention disclose a method and system for notifying a client when requested information is associated with a revoked digital certificate. Another embodiment of the present invention discloses a method for performing on-line status checking of digital certificates in conjunction with a request for information.

Specifically, embodiments of the present invention describe a communication system for performing on-line status checking of digital certificates. In one embodiment, the present invention describes an implementation of a secure communication system having a client and a server coupled together. The client requests information from the server. The information is associated with a digital certificate authenticating the information. A secure communication channel or session is established between the client and the server for checking the revocation status of the digital certificate. As such, further authentication of any communication between the client and the server is unnecessary. A status request pertaining to the digital certificate associated with the requested information is sent by the client to the server. The server checks the revocation status of the digital certificate against a certificate revocation list accessible by the server. The server notifies the client as to the revocation status of the digital certificate prior to any transmission of information.

In another embodiment, the present invention describes a method for performing on-line status checking of digital certificates. Specifically, the present embodiment establishes a secure communication session between a client and a server. The client authenticates the server while establishing the secure communication session. As such, any further communication between the server and the client need not be further encrypted and signed. Then, the client makes a certificate status check request to the server. The server, upon receiving the request, determines the status of the digital certificate by comparing the digital certificate against a signed certificate revocation list that is accessible by the server. The server then notifies the client as to the revocation status of the digital certificate.

### BRIEF DESCRIPTION OF THE DRAWINGS

FIG. 1 is a logical block diagram of an exemplary client that requests information, or a server that transfers information, in accordance with an embodiment of the present invention.

FIG. 2 is a block diagram of an exemplary communication system that provides for notification of a revocation status of a digital certificate associated with requested information, in accordance with one embodiment of the present invention.

FIG. 3 is a flow chart illustrating steps in a method for authenticating a digital certificate that is associated with requested information, in accordance with one embodiment of the present invention.

FIG. 4 is a flow chart illustrating steps in a method for authenticating a digital certificate that is associated with requested information, in accordance with one embodiment of the present invention.

### DETAILED DESCRIPTION OF THE INVENTION

Reference will now be made in detail to the preferred embodiments of the present invention, a method and system for performing on-line status checking of digital certificates, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Notation and Nomenclature

Some portions of the detailed descriptions which follow are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “establishing,” “checking,” “determining,” “notifying,” “authenticating,” “terminating,” “maintaining,” “sending,” “displaying,” “recognizing,” or the like, refer to the action and processes of a computer system, or similar electronic computing device, including an embedded system, that manipulates and transforms data represented as physical (electronic) quantities within the computer system's registers and memories into other data similarly represented as physical quantities within the computer system memories or registers or other such information storage, transmission or display devices.

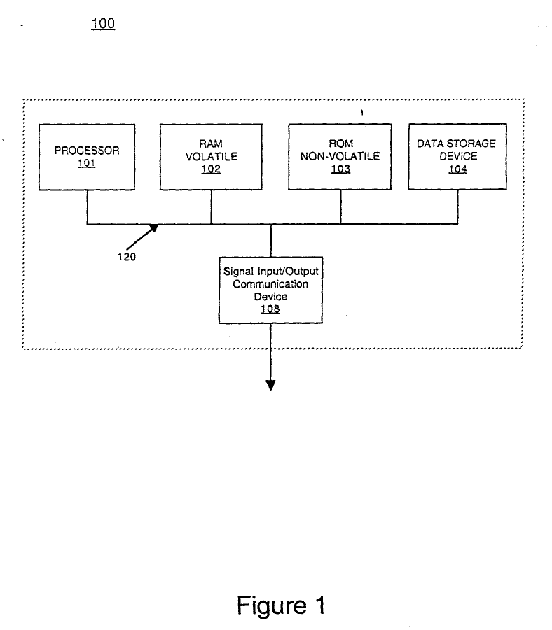

Referring to FIG. 1, embodiments of the present invention are comprised of computer-readable and computer-executable instructions which reside, for example, in computer-readable media of a computer system, such as a client that requests information, or a server that stores and transfers information to the client. FIG. 1 is a block diagram of exemplary embedded components of such a computer system 100 upon which embodiments of the present invention may be implemented. Exemplary computer system 100 includes an internal address/data bus 120 for communicating information, a central processor 101 coupled with the bus 120 for processing information and instructions, a volatile memory 102 (e.g., random access memory (RAM), static RAM dynamic RAM, etc.) coupled with the bus 120 for storing information and instructions for the central processor 101, and a non-volatile memory 103 (e.g., read only memory (ROM), programmable ROM, flash memory, EPROM, EEPROM, etc.) coupled to the bus 120 for storing static information and instructions for the processor 101.

With reference still to FIG. 1, an optional signal Input/Output (I/O) device 108 is shown. The I/O device 108 is coupled to bus 120 for providing a communication link between the computer system 100 and other electronic devices. As such, signal I/O device 108 enables the central processor unit 101 to communicate with or monitor other electronic systems that are coupled to the computer system 100.

On-line Digital Certificate Status Checking

This disclosure describes a method for performing on-line status checking of digital certificates. Another embodiment of the present invention discloses a method and system for notifying a client when requested information is associated with a revoked digital certificate.

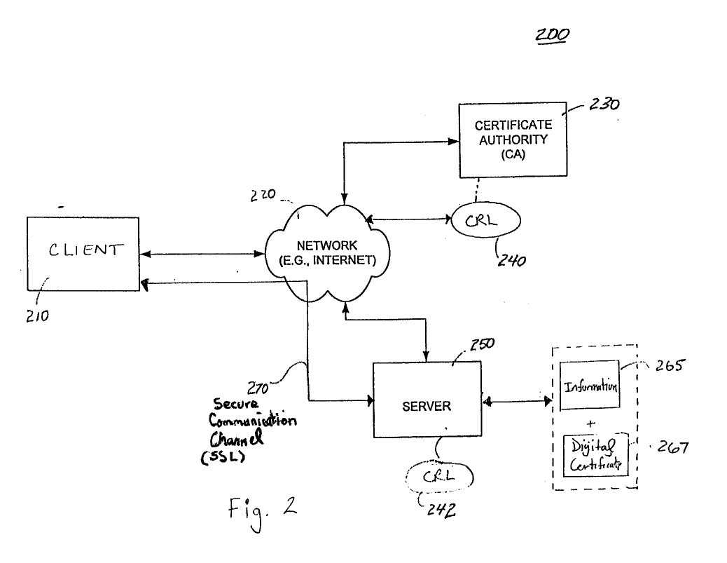

FIG. 2 depicts an exemplary communication system 200 that is capable of performing on-line status checking of a digital certificate in conjunction with a request for information 265, in accordance with one embodiment of the present invention. In system 200 a client 210 requests information from a server 250 over a network 220 (e.g., the Internet). Both the server 250 and the client 210 are coupled together through the network 220. For example, in one embodiment, the request for information may be in conjunction with a periodic polling of the server by the client for information. The information could be software patches that are needed by the client to incorporate into an operating system utilized by the client's local network.

The server 250 stores or has access to the requested information. As such, the server 250 is a source of the requested information 265. The requested information is associated with a digital certificate 267 that authenticates or validates the information. The digital certificate 267 has been issued and signed by the certificate authority (CA) 230.

The certificate authority 230 is coupled to the network 220. The CA 230 issues the digital certificate 267 that is used to authenticate the information 265. In addition, the CA 230 generates a certificate revocation list 240 that discloses any revocation of certificates that have been generated by the CA 230.

In one embodiment, the CRL 240 is downloaded by the server 250 through the network 220. The downloaded CRL 242 is located at the server. Further, the CRL 242 that has been downloaded at the server 250 is periodically updated by the server 250 to ensure that the most current CRL 240 is available at the server 250. It is important to note that the CRL 242 may not be as current as the CRL 240 in the present embodiment since the server is not maintaining the CRL.

In another embodiment, the CRL 240 is maintained by the server 250. As such, the CRL 242 located at and accessed by the server 250 is assured to be the most current CRL 240 available.

In still another embodiment, the CRL 242 is augmented with the latest revocation status information. For example, the server 250 is notified of the revocation status of the digital certificate 267. In one case, the private key generated and associated with the digital certificate 267 was compromised (e.g., stolen or duplicated). The server is notified because the holder, or the company affiliated with the holder, of the compromised key understands that the server 250 contains information that is authenticated by the compromised private key (e.g., the company server). In addition, the CA that generated the digital certificate 267 is also notified of the revocation status. As such, the server 250 augments the CRL 242 to reflect the revoked status of the digital certificate 267. In the present case, the CRL 242 may reflect that fact that certificate 267 has been revoked even before the CRL 240 generated by the CA 230 has received notice of the revoked status.

System 200 also includes a secure communication channel 270 over which a secure communication session can be conducted between the client 210 and the server 250. In one embodiment, the secure channel 270 is established through an authentication protocol supported by Secure Sockets Layer (SSL). A SSL layer is located at both the server 250 and the client 210. The secure channel 270 allows for secure communication between the client 210 and the server 250 without the continued use of authenticating digital certificates. As such, a client 210 may initiate and request a revocation status check of multiple digital certificates at one time over the secure channel 270. As such, the server need not authenticate each reply of status for every digital certificate that is checked.

In system 200, the server 250 checks the revocation status of digital certificates (e.g., 267) associated with and in conjunction with requests for information (e.g., 265) that are received at the server 250. The server 250 notifies the client 210 as to the revocation status of each of the digital certificates associated with requested information over the secure communication channel 270 before the server 250 transfers over any requested information (e.g., 265). As such, the client 210 may choose to stop requesting further transmission of information to and from the server 250 should an associated digital certificate prove to be invalid.

Further, since this on-line status checking occurs over the secure channel 270 and at a source of the information (the server 250), the confidentiality, integrity, and the identity of the information transferred over the network 200 from the server 250 to the client is protected.

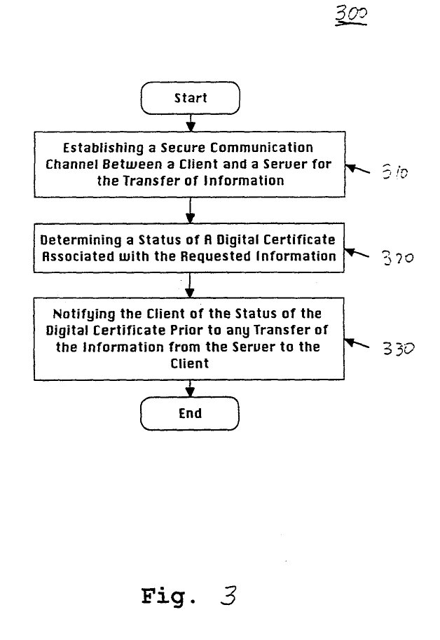

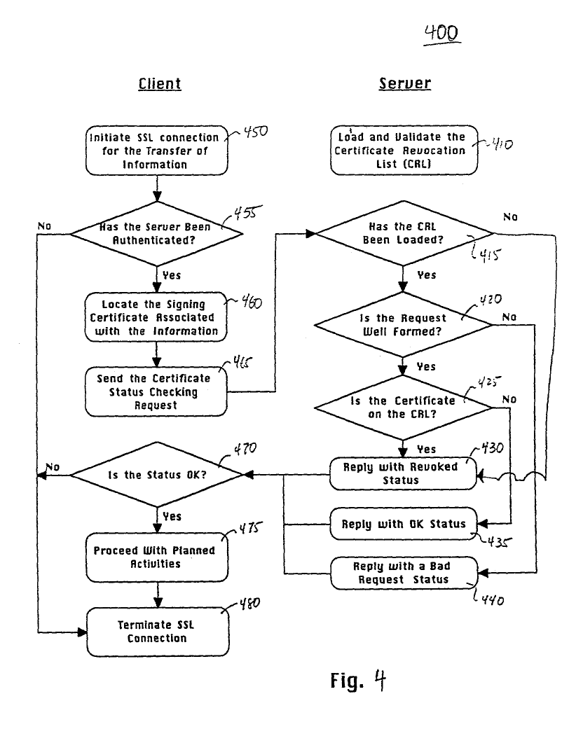

FIGS. 3 and 4 illustrate methods of automatically validating digital certificates in conjunction with requests for information from a client, in accordance with embodiments of the present invention. As such, embodiments describe methods for automatically stopping software clients from making further object download requests (e.g., information) from a server once a signing private key of a digital certificate that has been found to be compromised. The digital certificate authenticates objects or information contained within the server. In one embodiment, the methods described in FIGS. 3 and 4 are implemented in the communication system 200 of FIG. 2.

FIG. 3 illustrates a flow chart 300 for automatically validating a digital certificate, in accordance with one embodiment of the present invention. FIG. 4 is a flow chart 400 that illustrates further steps in the method described in flow chart 300, in accordance with another embodiment of the present invention.

Referring now to FIG. 3, the embodiment described by flow chart 300 establishes a secure communication session between a client and a server in step 310. The client initiates the establishment of the secure communication session through a server authentication process supported by a Secure Socket Layer (SSL) for the purpose of requesting one or more items of information (e.g., software objects or patches) from the server. Each of the items of information of interest to the client are validated by a digital certificate. For example, the client may be polling the server for the latest software patches issued by the server to be implemented on the client's network operating system. In another embodiment, the secure communication channel is established only for the purposes of validating or authenticating digital certificates.

Further, the secure communication session is established prior to any download request by the client to the server. This ensures all subsequent communications between the client and the server are conducted over the secure communication session in a SSL session. As such, all communication in the SSL session is private and reliable. There is no possibility of third party eavesdropping, third party impersonation, or information tampering, etc. over the SSL session. This removes the need to individually sign the digital certificates' status information being exchanged between the client and the server during the SSL session.

Thereafter, the client consults with the server about the current revocation status of a digital signing certificate of interest to the client. As such, the present embodiment determines the status of a digital certificate at the server in response to a status request from the client in step 320. The client previously has located a digital certificate that is associated with an item of interest to be requested by the client. In another embodiment, the client could send more than one status request over the secure communication session to have the server determine the status of more than one digital certificate.

Also, the present embodiment in flow chart 300 notifies the client of the status of the digital certificate prior to any transfer of the information from the server to the client. The notification is sent from the server to the client over the secure communication session. If the status of the certificate in question is of any status other than “OK,” then subsequent download attempts will not be made by the client.

Referring now to FIG. 4, flow chart 400 illustrates further steps in a method of performing on-line status checking of digital certificates in conjunction with download requests is described, in accordance with one embodiment of the present invention. The present embodiment begins with the server, as a background process, loading in a digitally signed certificate revocation list (CRL), in step 410. The CRL loaded at the server is periodically updated to ensure that the most current CRL is accessible by the server. In another embodiment, the CRL is maintained by the server to ensure that the most current CRL is accessible by the server.

In one embodiment, the server validates the signature or digital certificate associated with the CRL. If this signature validation process cannot be successfully completed, then the server will assume that all certificates been revoked.

Next, prior to any download request by a client to a server, the client first establishes a secure communication session to the server through a server authentication process supported by Secure Socket Layers (SSL) at both the client and the server in step 450 of the present embodiment. The secure communication session is to establish a SSL connection between the client and the server. The client initiates the authentication protocol in order to authenticate the server.

In condition step 455, the present embodiment determines if the server has been authenticated. Should the server fail to be authenticated, then the client terminates the establishment of the secure communication session in step 480.

However, if the server is authenticated in condition step 455, the present embodiment locates the signing certificate in question in step 460. In one embodiment, prior to sending any download request, the client has prior knowledge of the identity of digital certificates that are associated with items of interest or software objects that may be available at the server. For example, in the case where the client is polling the server for software patches, for example, in a polling request, the client does not know beforehand what information, if any, is available. However, should any information be available for the client, the client has previously obtained a digital certificate and can authenticate the digital certificate prior to downloading the information.

In step 465, the present embodiment sends a certificate status checking request to the server. The client and the server communicate to determine the current status of the previously located digital certificate in question. As such, the client can form the status request into a well-defined Hypertext Transfer Protocol (HTTP) POST request and send the request to the client. The prescribed format of the HTTP POST request is pre-determined and understood by the server. The prescribed format of the HTTP POST request helps to deter unauthorized access to the server.

In condition step 415, the server receives the certificate status checking request. The present embodiment determines if the CRL has been loaded at the server, in condition step 415. Independent from the certificate status request 465, the server may have previously loaded the certificate revocation list (CRL), for example, upon bootup, in step 410. If the CRL has been loaded, then the present embodiment proceeds to step 420. If the CRL has not been loaded, then the present embodiment proceeds to step 430 to send a reply from the server to the client indicating that the digital certificate in question is invalid. In this case, the server assumes that the digital certificate is invalid.

In condition step 420, the present embodiment determines if the certificate status checking request is well formed, in other words, follows the format prescribed by the server. If the request does not follow the prescribed format, the present embodiment proceeds to step 440. In step 440, the present embodiment sends a reply from the server to the client indicating a bad request status from the server to the client. In other words, the status is “not OK.”

On the other hand, if the request follows the prescribed format, the present embodiment proceeds to condition step 425. In condition step 425, the present embodiment determines the revocation status of the digital certificate in question. In one embodiment, the server checks the digital certificate against the loaded CRL to determine if the digital certificate has been revoked.

If the digital certificate is located on the CRL, then the present embodiment proceeds to step 430 and sends a reply from the server to the client indicating the digital certificate has been revoked. In other words, the status is “not OK.”

If the digital certificate is not located on the CRL, then the present embodiment determines that the digital certificate has not been revoked and proceeds to step 435. In step 435, the present embodiment sends a reply from the server to the client indicating that the digital certificate has not been revoked. In other words, the status is “OK.”

From each of the steps 430, 435, and 440, the present embodiment sends each of the replies from the server back to the client. The present embodiment determines if the status of the digital certificate in question is “OK,” in other words, that the digital certificate has not been revoked, in condition step 470. If the status is “not OK,” then the client proceeds to step 480 and terminates the SSL connection between the client and the server, in accordance with one embodiment.

On the other hand, if the status is “OK,” then the flow chart 400 proceeds to step 475. In step 475, if the digital certificate in question has not been revoked, and is “OK,” then the client proceeds with planned activities, such as sending a formal request to the client for the information associated with the digital certificate in question.

In one embodiment, the process in flow chart 400 is implemented before transferring any software patches that have been polled by the client from the server. In this case, a secure SSL connection is established between the client and the server prior to any transfer of the software patches. As discussed previously, a status request regarding a previously determined digital certificate that would be associated with any available software patch is sent from the client to the server. The server, over the secure SSL connection sends the revocation status of the digital certificate back to the client. Thereafter, the client can choose to continue or discontinue the transfer of the available software patches given the revocation status information transferred. As such, the present embodiment provides for an on-line status checking of digital certificates in conjunction with a poll for software patches in a secure manner.

In one embodiment, subsequent communication between the client and the server is conducted over the secure communication session that is private and reliable. In this way, the request for information and the transfer of information is conducted over the secure communication session and precludes the need for further signatures with digital certificates validating the communication.

In another embodiment, since the client and the server communicate over a secure communication session, the client can send multiple certificate status checking requests to the server. Each of the requests need not be accompanied with a digital signature authenticating the request. Thereafter, the server can determine and send notification back to the client regarding the revocation status of each of the requested digital certificates. Each of the notifications are sent without the need of any additional digital signing, and are sent prior to any transfer of requested and associated items of information.

The methods of embodiments illustrated in flow charts 300 and 400 are implemented in a complementary protocol that is understood by both the client and the server, in accordance with one embodiment of the present invention. As such, a secure way is enabled to determine the revocation status of digital certificates on-line. In this way, the server can automatically stop software clients from making further object download requests should a private key associated with items of information at the server be compromised.

While the methods of embodiments illustrated in flow charts 300 and 400 show specific sequences and quantity of steps, the present invention is suitable to alternative embodiments. For example, additional steps can be added to the steps presented in the present embodiment. Likewise, the sequences of steps can be modified depending upon the application.

Embodiments of the present invention, providing for on-line status checking of digital certificates in conjunction with requests for information, is thus described. While the present invention has been described in particular embodiments, it should be appreciated that the present invention should not be construed as limited by such embodiments, but rather construed according to the below claims.

What is claimed is:

1. A communication system comprising:
a communication network;
a server coupled to said communication network for determining a revocation status of a digital certificate in response to a status request;
a client coupled to said server through said communication network for transmitting said status request to said server, wherein a reply from said server to said client notifies said client of said revocation status; and
an on-line secure communication session over said communication network between said client and said server for securely transferring said reply automatically.

2. The communication system as described in claim 1, wherein said digital certificate is associated with information requested by said client and transferred to said client by said server.

3. The communication system as described in claim 1, wherein said client initiates an authentication protocol supported by a Secure Socket Layer (SSL) to authenticate said server in order to establish said secure communication session with said server.

4. The communication system as described in claim 1, wherein said secure communication session is a Secure Socket Layer (SSL) communication session.

5. The communication system as described in claim 1, further comprising:
a digitally signed certificate revocation list (CRL) accessed by said server to determine said revocation status of said digital certificate.

6. The communication system as described in claim 5, wherein said CRL is maintained by said server so that said server can access the most current CRL.

7. The communication system as described in claim 1, wherein said server sends a valid reply to said client over said secure communication session if said digital certificate has not been revoked, and sends an invalid reply to said client over said secure communication session if said digital certificate has been revoked.

8. The communication system as described in claim 1, wherein said server loads a digitally signed certificate revocation list (CRL) upon startup, and authenticates said CRL, and assumes all digital certificates are revoked if said CRL cannot be authenticated.

9. The communication system as described in claim 1, wherein said client polls said server for said information that is a software patch.

10. The communication system as described in claim 1, wherein said status request is a Hypertext Transfer Protocol (HTTP) POST request.

11. A communication system comprising:
a communication network;
a server coupled to said communication network for determining a revocation status of a digital certificate in response to a status request associated with a poll for a software patch authenticated by said digital certificate;
a client coupled to said server through said communication network for initiating said poll and transmitting said status request to said server, wherein a reply from said server to said client notifies said client of said revocation status; and
an on-line secure communication session over said communication network between said client and said server for securely transmitting said reply automatically.

12. The communication system as described in claim 11, wherein said client initiates an authentication protocol supported by a Secure Socket Layer (SSL) to authenticate said server in order to establish said secure communication session with said server.

13. The communication system as described in claim 11, wherein said secure communication session is a Secure Socket Layer (SSL) communication session.

14. The communication system as described in claim 11, further comprising:
a digitally signed certificate revocation list (CRL) accessed by said server to determine said revocation status of said digital certificate, wherein said CRL is maintained by said server so that said server can access the most current CRL.

15. The communication system as described in claim 11, wherein said server sends a valid reply to said client over said secure communication session if said digital certificate has not been revoked, and sends an invalid reply to said client over said secure communication session if said digital certificate has been revoked.

16. The communication system as described in claim 11, wherein said server loads a digitally signed certificate revocation list (CRL) upon startup, and authenticates said CRL, and assumes all digital certificates are revoked if said CRL cannot be authenticated.

17. The communication system as described in claim 11, wherein said status request is a Hypertext Transfer Protocol (HTTP) POST request.

18. The communication system as described in claim 11, wherein said server transmits said reply before transmitting said software patch.

19. The communication system as described in claim 11, wherein said server stores said information.

20. A method of validating a digital authentication comprising:
a) establishing a secure on-line communication session between a client and a server, wherein said client authenticates said server and requests status information of a digital certificate from said server over said secure communication session;
b) determining a revocation status of said digital certificate at said server in response to a status request from said client; and
c) notifying said client of said revocation status by securely transferring said revocation status to said client.

21. The method of validating as described in claim 20, wherein c) further comprises:
securely transferring said revocation status prior to any transfer of information accessible by said server and authenticated by said digital certificate.

22. The method of validating as described in claim 20, wherein a) further comprises:
requesting said status information when polling said server for information associated with said digital certificate; and wherein
b) and c) are performed automatically in response to said status request.

23. The method of validating as described in claim 20, wherein said client authenticates said server through an authentication protocol supported by a Secure Socket Layer (SSL) that is initiated by said client when establishing said secure on-line communication session.

24. The method of validating a digital authentication as described in claim 23, further comprising:
terminating said secure on-line communication session if said server is not authenticated.

25. The method of validating a digital authentication as described in claim 20, wherein a) further comprises:
establishing said secure communication session to transmit said status request and a reply to said status request over said secure communication session.

26. The method of validating a digital authentication as described in claim 20, wherein b) comprises:
checking said digital certificate against a digitally signed certificate revocation list (CRL).

27. The method of validating a digital authentication as described in claim 26, further comprising:
maintaining said CRL by said server so that the most current CRL is accessible by said server.

28. The method of validating a digital authentication as described in claim 20, wherein c) comprises:
sending a first reply over said secure communication session indicating said revocation status is valid from said server to said client, if said digital certificate has not been revoked; and
sending a second reply over said secure communication session indicating said revocation status is invalid from said server to said client, if said digital certificate has been revoked.

29. The method of validating a digital authentication as described in claim 20, wherein c) comprises:
notifying said client of said revocation status with a reply without including a second digital certificate authenticating said reply over said secure communication session.

30. The method of validating a digital authentication as described in claim 20, further comprising:
b) determining a second revocation status of a second digital certificate in response to a second status request from said client, said client requesting second information, said second information associated with said second digital certificate that authenticates said second information; and
c) notifying said client of said second revocation status of said prior to any transfer of said second information.

31. A method of validating a digital authentication comprising:
a) establishing a secure on-line communication session with a client for the transfer of a software patch to said client in response to a polling request for said software patch that is authenticated by a digital certificate;
b) determining a revocation status of said digital certificate in response to a status request from said client; and
c) notifying said client of said revocation status of said digital certificate prior to any transfer of said software patch to said client over said secure communication session.

32. The method of validating as described in claim 31, wherein said a), b), and c) are performed automatically.

33. The method of validating a digital authentication as described in claim 31, wherein b) comprises:
checking said digital certificate against a digitally signed certificate revocation list (CRL).

34. The method of validating a digital authentication as described in claim 31, wherein a), b) and c) are performed each time said client polls said server for the transfer of said software patch.

35. The method of validating a digital authentication as described in claim 31, further comprising:
terminating said secure communication session if said revocation status indicates said digital certificate has been revoked; and
continuing said secure communication session if said revocation status indicates said digital certificate is valid.

36. The method of validating a digital authentication as described in claim 31, wherein c) comprises:
sending a first reply over said secure communication session indicating said revocation status is valid from said server to said client, if said digital certificate has not been revoked; and
sending a second reply over said secure communication session indicating said revocation status is invalid from said server to said client, if said digital certificate has been revoked.

37. The method of validating a digital authentication as described in claim 31, further comprising:
verifying said status request follows a prescribed format; and
sending a reply indicating said status request is bad if said status request does not follow said prescribed format.

38. The method of validating a digital authentication as described in claim 37, further comprising:
terminating said secure communication session if said status request is bad.

39. The method of validating a digital authentication as described in claim 31, further comprising:
before step b), loading a digitally signed certificate revocation list (CRL) at said server;
validating and authenticating said CRL; and
assuming all digital certificates are invalid if said CRL is invalid.

40. The method of validating a digital authentication as described in claim 31, wherein c) comprises:
notifying said client of said revocation status with a reply without including a second signature validation on said reply over said secure communication session.
